(19) United States
(12) Patent Application Publication
(10) Pub. No.: US 2024/0215118 A1
(43) Pub. Date: Jun. 27, 2024

(54) FLEXIBLE HEATER AND METHOD FOR MANUFACTURING SAME

(71) Applicant: LATTRON CO.,LTD., Daejeon (KR)

(72) Inventors: Chungkook Lee, Daejeon (KR); Jaechoon Lee, Daejeon (KR); Hyunseong Lee, Daejeon (KR)

(21) Appl. No.: 18/556,507

(22) PCT Filed: Apr. 11, 2022
(86) PCT No.: PCT/KR2022/005222

§ 371 Date: Oct. 20, 2023

(30) Foreign Application Priority Data
Apr. 22, 2021 (KR) 10-2021-0052419
Mar. 29, 2022 (KR) 10-2022-0039187

(51) Int. Cl. H05B 3/36; B32B 3/26; B32B 9/00; B32B 9/04; B32B 37/10; B32B 37/18; G01K 7/16

(52) U.S. Cl. CPC H05B 3/36; B32B 3/263; B32B 3/266; B32B 9/005; B32B 9/041; B32B 37/10; B32B 37/18; G01K 7/16; B32B 2255/06; B32B 2255/205; B32B 2255/26; B32B 2307/206; B32B 2307/302; B32B 2307/304; B32B 2307/7376; B32B 2457/00; H05B 2203/017

(57) ABSTRACT

A flexible heater includes a heating module including: a plate-shaped heater; a flexible electrical insulator surrounding the plate-shaped heater; and a flexible sheet surrounding the plate-shaped heater and the electrical insulator. The heating module has a plurality of through-spaces at positions where a heater pattern of the plate-shaped heater is not formed, and a lower sheet and an upper sheet are interconnected in the through-spaces, such that the sheet may maintain its shape without being delaminated even if the shape of the heating module is changed to be curved or bent in order to increase heating efficiency.

### CROSS-REFERENCE TO RELATED APPLICATIONS

This application is a National phase entry pursuant to 35 U.S.C. 371 of International Application No. PCT/KR2022/005222, filed on Apr. 11, 2022, which claims priority to Korean Patent Application No. 10-2021-0052419, filed on Apr. 22, 2021, and Korean Patent Application No. 10-2022-0039187, filed on Mar. 29, 2022, the disclosures of which are incorporated by reference herein in their entireties.

### TECHNICAL FIELD

The present disclosure relates to a flexible heater and a method for manufacturing a flexible heater.

### BACKGROUND ART

Heaters generally refer to heaters using linear heating elements, such as nickel/chrome wire heaters or carbon wire heaters, but recently, flat heaters with these heating elements formed in a planar shape are expanding their use in various fields.

Unlike conventional linear heaters, flat heaters have the advantage of having a two-dimensional area and dissipating heat evenly over the entire area to heat a certain wide area evenly, so they are widely applied to floor heating, snow melting, or car seat heaters, and the like.

The present inventors have commercialized a film heater including an etched-foil resistance heating element laminated between flexible insulating layers, and these film heaters are applied to various purposes such as home appliances, ESS (energy storage system), hot water mats, LCD/LED, car batteries, and water purifiers according to the temperature range (100, 200, 300° C.).

However, when the flat heater was first developed, it was sufficient to achieve the purpose of heating one side of the object to be heated, such as the floor face or the car seat, but recently, the desire to use it further in heating various medium and large tank containers with large volumes.

That is, if heaters are not only formed flat and flexible, but these flat heaters are also implemented as a ‘flexible flat heater’ that may be processed into various shapes with a large surface area, these flat heaters may be arranged three-dimensionally in a container to apply an immersion method of directly heating water or liquid, and accordingly, it is expected that a heater with excellent heating effect may be manufactured.

Conventional flat heaters do not have excellent heating efficiency because they only heat one side, such as the bottom of the container, but a new system may be created in which the water or liquid in the container may be directly heated by arranging multiple independent flat heaters enabling three-dimensional heating within the target object.

However, in order to implement the ‘flexible flat heater (flexible heater)’ in the present disclosure, the following two problems should be solved.

The first problem is that the basic form of the flexible flat heater is that a film heater is formed on a flexible base film, so although the flat heater itself is very flexible, it is difficult to maintain a sturdy shape, and accordingly, there is a difficulty in that a solid final product may only be obtained by adding an exterior member that supports the flat heater.

In order to make a heater that is sturdy yet flexible, as described in Korean Patent Publication No. 10-0772069, a method of manufacturing ‘heat generating unit in which a film heater and an exterior member are pressed’ in which a film heater is inserted into an exterior member of an oval-shaped metal tube and then rolled using a rolling roller has been attempted, but this rolling process has a disadvantage of requiring separate rolling equipment and a difficulty in controlling the precision of the electrical and electronic component manufacturing process.

The second problem is that even if the heat generating unit, i.e., the flat heater, is made by pressing the film heater and the exterior member through the rolling process described above, the prior art does not allow for improvement of mechanical stability during processing, such as bending of the pressed flat heater, and the like.

That is, even if a flat heater with a certain level of strength is manufactured by attaching an exterior member, in order to improve the heating performance by increasing the surface area of the flat heater, processing such as bending should be performed on the flat heater, but in the conventional method of manufacturing the pressed heat generating unit, there are problems such as peeling of the film heater and exterior member that may occur when bending, and there has been no attempt to improve these problems.

Ultimately, in order to provide a ‘flexible flat heater (flexible heater)’ with excellent performance, it is necessary to keep in mind the addition of an exterior member to maintain the shape of the flat heater, as well as shape changes such as bending to improve the heating characteristics of the flat heater, and a technology is needed to solve problems such as delamination of a plate-shaped heater, an electrical insulator, and an exterior member surrounding the outside of the plate-shaped heater and electrical insulator of the flat heater.

Meanwhile, as prior art related to conventional film-type heaters, there are Japanese Patent Publication No. 2001-135463 and Japanese Patent Publication No. 2005-158274.

In Japanese Patent Publication No. 2001-135463, in order to resolve the non-uniformity between the center of the heater, which does not dissipate heat well, and an outer periphery of the heater, which dissipates heat well, a planar heater is disclosed in which a density per area of the film-type heating element is designed into different patterns at the center and the outer periphery of the heater.

In Japanese Patent Publication No. 2005-158274, a planar heater includes a heating element, support members covering the surroundings of the heating element, and an insulating layer disposed between the heating element and the support member and insulating between the support members, the insulating layer is made of ceramics, such that trouble-free and stable planar heater which may use an operating temperature of the heating element may be provided.

Meanwhile, Korean Patent Publication No. 10-0772069 discloses a ribbon heat generating unit for an auxiliary heating device including a ribbon heating element and an aluminum receiving member accommodating the ribbon heating element, and Korean Patent Publication No. 10-1037652 discloses a heater assembly that may reduce power consumption by increasing heat exchange efficiency with air by implementing a planar heating member, in which a thin metal strip is corrugated, as a heater to optimize power consumption, and a heating device using the same.

In addition, Korean Patent Publication No. 10-1416170 discloses a heater for drying laundry in which a planar heating member, as a unit heater, between base plates and receives electric power to generate heat has a structure that sequentially contacts a heat conduction plate member and a heat dissipation plate member to separately protect a connection area of a heater terminal, and Korean Patent Publication No. 10-2019-0010010 discloses a heating element including an insulating layer and a heating source laminated on the insulating layer and generating heat when current is applied, thereby increasing heat generation density, and a heater for vehicle air conditioning including the same.

Although Korean Patent Publication No. 10-0772069 and Korean Patent Publication No. 10-1037652 describe the basic technical characteristic of providing a heater assembly that may reduce power consumption by increasing the heating efficiency by implementing a corrugated (wrinkled) planar heating member as a heater, but there is absolutely no awareness of how to solve problems such as the combination of the heater, the insulator and the exterior metal and delamination that may occur.

### SUMMARY

The present disclosure relates to a flexible heater that includes a flexible plate-shaped heater formed at a center portion, a flexible electrical insulator surrounding the plate-shaped heater, and a flexible metal sheet surrounding the insulator, and has a high degree of freedom in shape deformation such as bending.

The present disclosure also relates to a flexible heater that includes a flexible plate-shaped heater, a flexible electrical insulator surrounding the plate-shaped heater, and a flexible metal layer surrounding the insulator, has a structure in which an upper metal layer and a lower metal layer of the metal layer are connected to each other in a reinforced manner, and has a high degree of freedom in shape deformation such as bending, sturdy characteristics, and improved durability.

The present disclosure also relates to a flexible heater that includes a flexible plate-shaped heater, a flexible electrical insulator surrounding the plate-shaped heater, a flexible metal layer surrounding the insulator, and a flexible temperature sensor, and has a high degree of freedom in shape deformation such as bending, sturdy characteristics, and improved durability, while having excellent temperature control and uniform heating characteristics.

Conventionally, there were few attempts to use flexible flat heaters in heating devices for medium-to-large-sized containers, but the purpose of the present disclosure is to provide a flat heater suitable for medium-to-large capacity tanks, and the like, and further to provide a ‘flexible heater’ that not only has excellent heating efficiency but also durability.

More specifically, the first object of the present disclosure is to provide a flexible heater whose shape may be freely modified.

The second object of the present disclosure is to provide a flexible heater that is sturdy and durable enough to prevent delamination of each element even if a shape of a flat heater including a heating module is changed due to bending or the like.

The third object of the present disclosure is to provide a flexible heater that may maximize a specific surface area per unit volume when an object to be heated is immersed in liquid.

The fourth object of the present disclosure is to provide a flexible heater that may independently measure a temperature of each part of a heating module by adding a temperature sensor and directly monitor a temperature of each part of an object to be heated.

The fifth object of the present disclosure is to provide a flexible heater that may maximize heat transfer by heating an object to be heated uniformly at a high speed, and may individually control heat generation of each heating module.

### BRIEF DESCRIPTION OF THE DRAWINGS

FIG. 1 is a perspective view illustrating a flexible heater according to a first embodiment of the present disclosure.

FIGS. 2 to 4 are views illustrating a process of manufacturing a sheet of the heating module according to the first embodiment of the present disclosure.

FIG. 5 is a cross-sectional view illustrating edges of the heating module according to the first embodiment of the present disclosure.

FIG. 6 is a partial cross-sectional view illustrating the heating module according to the first embodiment of the present disclosure.

FIGS. 7 and 8 are partial cross-sectional views illustrating a modified heating module of the flexible heater according to the first embodiment of the present disclosure.

FIG. 9 is a configuration diagram illustrating a flexible heater according to a second embodiment of the present disclosure.

FIG. 10 is a configuration diagram illustrating a flexible heater according to a third embodiment of the present disclosure.

FIGS. 11 to 15 are schematic diagrams illustrating modified shapes of the heating module according to the third embodiment of the present disclosure.

FIG. 16 is a graph comparing a temperature status of the heater in the flexible heater according to the third embodiment of the present disclosure.

### DETAILED DESCRIPTION

According to an embodiment of the present disclosure, a flexible heater includes a plate-shaped heater having flexibility, an electrical insulator surrounding the plate-shaped heater and having flexibility, and a sheet surrounding the plate-shaped heater and the electrical insulator and having flexibility. Here, the sheet is a term that refers to an upper sheet and a lower sheet which have flexibility.

As used herein, a ‘heating module’ in the present disclosure includes the flexible plate-shaped heater, the flexible electrical insulator surrounding the plate-shaped heater, and a flexible sheet surrounding the electrical insulator, and refers to an area where heating actually occurs.

In the heating module of the present disclosure, a plurality of through spaces penetrating the sheet are arranged in a certain manner based on a position where a heating pattern of the plate-shaped heater is not formed, and part of the plurality of through spaces may be configured such that a lower sheet and an upper sheet are connected to each other by a connector therein.

The connector may be configured such that the through spaces are unitarily connected through a connection means or a fusion material, and a connection portion of the connector and the lower and upper sheets is airtight. The connection means may include a rivet connection means, and as the fusion material, a brazing material may be filled in the through space in a brazing fusion manner. In the case of rivets, a rivet coated with a material having a similar coefficient of thermal expansion to that of the sheet may be desirably applied.

The heating module may be configured such that a thickness of edges on opposite sides is relatively thinner than a thickness of a center portion, and edges of the lower sheet and the upper sheet are sealingly connected.

The heating module may be configured such that the thickness of the edges on opposite sides is relatively thinner than the thickness of the center portion, and edges of the lower sheet and the upper sheet are joined by a joining means to form a weld surface.

The weld surface may be configured to have peaks and valleys formed at regular intervals along a surface through welding or surface processing.

The plate-shaped heater may be formed as a fabric-type heater or a film-type heater including at least one conductor of silver, copper, CNT, or graphene as a main component coated with a polymer.

The plate-shaped heater may be configured such that heating elements made of an alloy sheet such as nichrome or SUS, aluminum, copper or the like are formed at regular intervals as an electrical resistance circuit to sense a temperature during heating.

The electrical insulator may be configured to have a two or more-layer or multi-layer structure in which thermally conductive insulating layers and adhesive layers are alternately laminated.

The electrical insulator may be configured such that the insulating layer includes one or more ceramic layers including at least one of mica, silica wool, zirconia, and thin-film alumina, and the adhesive layer is formed of a ceramic-based adhesive.

The electrical insulator may be heated in opposite directions or may be configured to be heated in one direction by stacking a heat insulating layer on one side of the insulating layer.

The heat insulating layer may be formed as a thin insulating film in which hollow silica or glass is dispersed, or fine bubbles are widely distributed. The heat insulating layer may include aerogel polyimide sheet, ceramic sheet, and the like.

The sheet may be formed of a metal layer including any one of aluminum, copper, SUS, nichrome, and nickel-based alloy.

The sheet may be configured such that a coating layer including a parinrene-based polymer material or a metal thin film is additionally formed on a surface of the metal layer. Here, the coating layer includes a parinrene-based polymer material or a metal thin film to maintain airtightness on the surface of the sheet.

In addition, the flexible heater according to the present disclosure includes a heating module including a heater, an electrical insulator surrounding the heater and having flexibility, and a sheet surrounding the heater and the electrical insulator.

The heating module may be configured such that it shape is bent and deformed three-dimensionally and a surface area of the heater in contact with a heating medium in a certain heating space is expanded.

The flexible heater may further include a shape maintainer for maintaining a shape of the heating module or maintaining a shape of the heater at equal intervals when the heating module is stacked in one or more layers.

The heating module may be configured to be curved and deformed in any one of concentric, symmetrical, radial, and wavy shapes.

The concentric heating module may be configured such that a radius is gradually expanded while a spacing in a concentric direction from a central bent portion is kept constant, and opposite ends are arranged in the same direction.

The symmetrical heating module may be configured such that a plurality of bent portions are formed symmetrically in a facing direction and opposite ends are arranged in the same direction.

The radial heating module may be configured such that a flat portion having a predetermined length is formed along a circumferential surface between an outer bent portion and an inner bent portion, and a spacing between the outer bent portions is relatively wider than a spacing between the inner bent portions.

The waveform heating module may be formed such that convex portions and concave portions are alternately arranged having a certain area.

The heating module may be configured to further include a temperature sensor that is mounted along an inner surface of the sheet and detects a temperature for each part.

The temperature sensor may have a structure in which thin sensing element is stacked on a flexible sheet-like insulating layer on which internal wiring electrodes are formed.

The sensing element of the temperature sensor may be made of any one of a negative temperature coefficient thermistor element material, copper, nickel, nickel-based alloy, platinum, and platinum-based alloy.

According to an embodiment of the present disclosure, a method of manufacturing a flexible heater includes forming a plate-shaped heater by stacking a plurality of heater patterns on an insulating polymer film; forming an electrical insulator by alternately laminating thermally conductive insulating layers and adhesive layers on a surface of the plate-shaped heater; forming a sheet by disposing a lower sheet and an upper sheet on the electrical insulator; forming a heating module by pressing a structure in which the plate-shaped heater, the electrical insulator, and the sheet are stacked; and forming a through portion in the lower sheet and the upper sheet and caulking the through portion with a connector.

The method may further include: after forming the heating module by disposing and pressing the lower sheet and the upper sheet, sealing and connecting edges formed by the sheet.

The sealing and connecting the edge formed by the sheet may be configured to sealingly connect the edges by brazing or soldering through a clad sheet.

The method may further include: after forming the plate-shaped heater and forming the electrical insulator on the surface of the plate-shaped heater, forming a temperature sensor.

According to the flexible heater according to the present disclosure, a plurality of through spaces are formed in a heating module along a space where a plate-shaped heater and an electrical insulator are not partially formed, and the through spaces are caulked through connectors such as rivets or fusion welded with a brazing material, and accordingly, a sheet may maintain its shape without delamination when changing a shape of the heating module. Accordingly, the heat conductivity of the heating module may always be maintained constant regardless of the change in shape of the heating module, and durability may be increased and airtightness may be improved by preventing the heating module from being separated.

In addition, the processability of the heating module may be improved by configuring an edge thickness of the heating module to be relatively thinner than a flat portion.

In addition, after forming a weld surface using a brazing material or nano ink material by putting edges of the sheet together, the weld surface may be laser processed or etched to form peaks and valleys, thereby increasing shape variability such as bending of the heating module.

In addition, the heating module may secure flexibility to be bendable into any shape and may increase a specific surface area per unit volume when immersed in liquid.

In addition, by embedding a temperature sensor with a plurality of sensing elements inside the heating module, it is possible to precisely measure each part of the heater and monitor a temperature status of the heater from the outside.

Hereinafter, embodiments of the present disclosure will be described in detail with respect to the drawings. However, this description is provided as an example, the present disclosure is not limited thereby, and the present disclosure is only defined by the scope of the claims to be described below. The embodiments described below may be modified into various forms without departing from the concept and scope of the present disclosure. As much as possible, identical or similar parts are indicated using the same reference numerals in the drawings.

The terminology used below is only for referring to specific embodiments and is not intended to limit the invention. As used herein, singular forms include plural forms unless phrases clearly indicate the contrary. As used in the specification, the meaning of ‘comprising (including)’ is to specify a specific property, area, integer, step, operation, element and/or component, and it does not exclude the existence or addition of another specific property, area, integer, step, operation, element, component and/or group.

Hereinafter, preferred embodiments of the present disclosure will be described. However, the following embodiment is only a preferred example of the present disclosure and the present disclosure is not limited to the following embodiment.

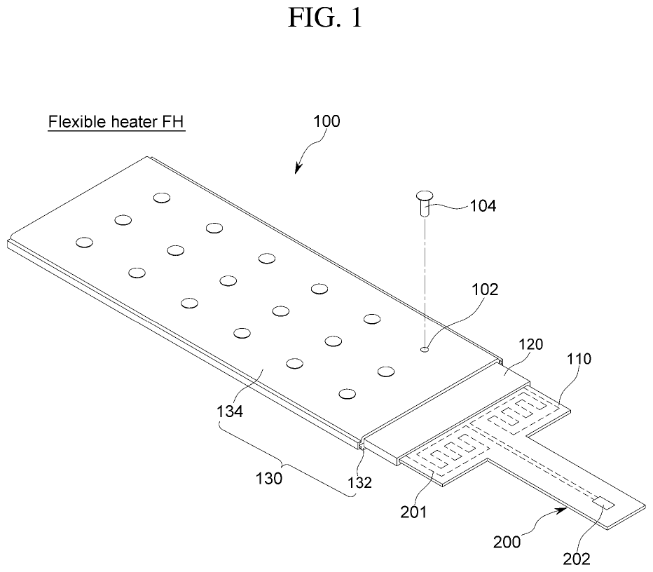

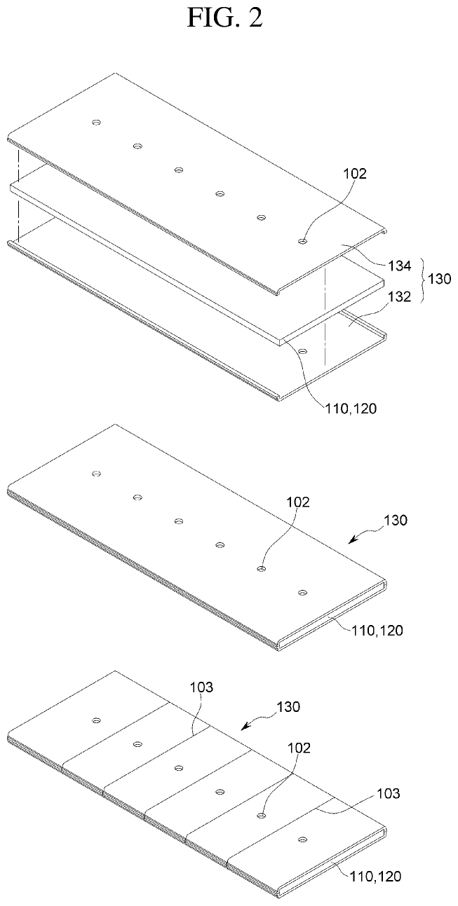

FIG. 1 is a perspective view illustrating a flexible heater according to a first embodiment of the present disclosure, FIGS. 2 to 4 are views illustrating a process of manufacturing a sheet of the heating module according to the first embodiment of the present disclosure, and FIG. 5 is a cross-sectional view illustrating edges of the heating module according to the first embodiment of the present disclosure.

As illustrated in FIGS. 1 to 5, a flexible heater FH according to the first embodiment of the present disclosure includes a heating module 100 and a terminal module 200 connected to the heating module 100 and supplying electrical energy. In such a case, a heater pattern 201 and a ground terminal 202 may be formed in the terminal module 200.

As illustrated in FIG. 1, the heating module 100 may include a plate-shaped heater 110 formed in the center and having flexibility, an electrical insulator 120 serving to insulate upper and lower surfaces of the plate-shaped heater 110 and having flexibility, and a sheet 130 including lower and upper sheets 132 and 134 having flexibility, wherein a plurality of through spaces (not illustrated) are formed at positions where a pattern of the plate-shaped heater 110 is not formed.

Here, the sheet 130 refers to a portion where the plate-shaped heater 110 and the electrical insulator 120 are surrounded by the lower sheet 132 and the upper sheet 134. That is, the sheet 130 is a general term that collectively refers to the lower sheet 132, the upper sheet 134, and their peripheral parts.

As illustrated in FIG. 1, the heating module 100 has a structure in which through holes 102 formed in a row in the lower and upper sheets 132 and 134 are interconnected to through spaces (not illustrated) formed in the plate-shaped heater 110 and the electrical insulator 120 through a connector. That is, the heating module 100 forms the through holes 102 in a plurality of rows in the lower and upper sheets 132 and 134 and forms the through spaces in the plate-shaped heater 100 and the electrical insulator 120 corresponding to the through holes 102 such that the through holes 102 and the through spaces are interconnected to each other with the connector.

Here, it is not that all the through spaces have to be connected by the connector. That is, part of the plurality of through spaces may be connected by the connector, and a remaining part thereof may be left without being connected through a connector. It is obvious that if some of the through spaces are left as is without being connected through a connector, the through holes 102 of the lower and upper sheets 132 and 134 should be treated airtight (hermetic) to prevent a heating medium (fluid) from flowing inside.

The connector may include a connection means 104 such as a rivet or the like made of a same material as the sheet 130. In the case of a typical rivet, it is preferable to use a rivet coated with a material having a similar coefficient of thermal expansion to that of the sheet.

The connector may be formed by brazing fusion welding by filling the through space with a brazing material. It is obvious that a connection portion between the lower sheet and the upper sheet should be airtight through this brazing fusion welding.

The connector thus is in close contact with surfaces of the lower and upper sheets 132 and 134 and does not escape from the through space, such that even if a shape of the heating module 100 is changed, the lower/lower sheets 132, 134 may not be delaminated from the plate-shaped heater 110 and the electrical insulator 120, and may serve to maintain their original shape.

Accordingly, as one of the key technical characteristics of the present disclosure, the connection/support structure of the present disclosure allows the lower and upper sheets 132 and 134 to maintain its shape well without being delaminated with respect to the plate-shaped heater 110 and the electrical insulator 120, thereby having the effect of preventing defects from occurring in the heater even when bending processing is applied to the flexible heater FH to increase a surface area and enhance heating efficiency.

FIGS. 2 to 4 are views illustrating a process of manufacturing a sheet of the heating module.

As illustrated in FIG. 2, in the heating module 100, the through holes 102 may be formed in a row in the lower and upper sheets 132 and 134 (upper drawing), and the lower and upper sheets 132 and 134 may be disposed with their opposite ends facing each other such that the plate-shaped heater 100 and the electrical insulator 120 may be inserted (middle drawing). The lower drawing illustrates a state in which a cutout portion 103 is formed at a portion where the flat heater is to be bent.

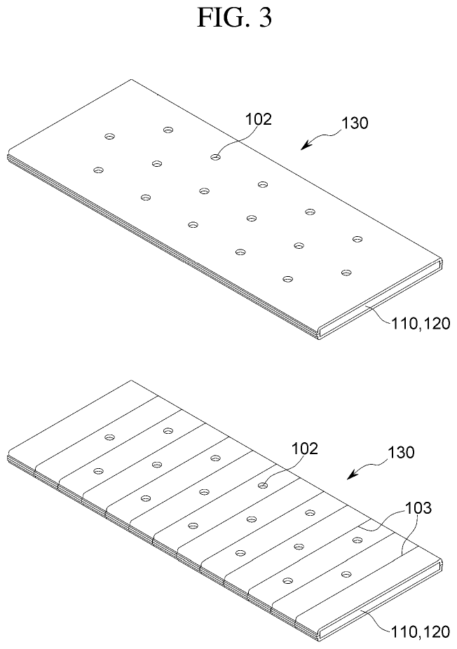

As illustrated in FIG. 3, in the sheet 130, a plurality of rows of the through holes 102 may be formed in the lower and upper sheets 132 and 134, and the lower and upper sheets 132 and 134 may be disposed with their opposite ends facing each other such that the plate-shaped heater 100 and the electrical insulator 120 may be inserted. The lower drawing illustrates a state in which the cutout portion 103 is formed at a portion where the flat heater is to be bent.

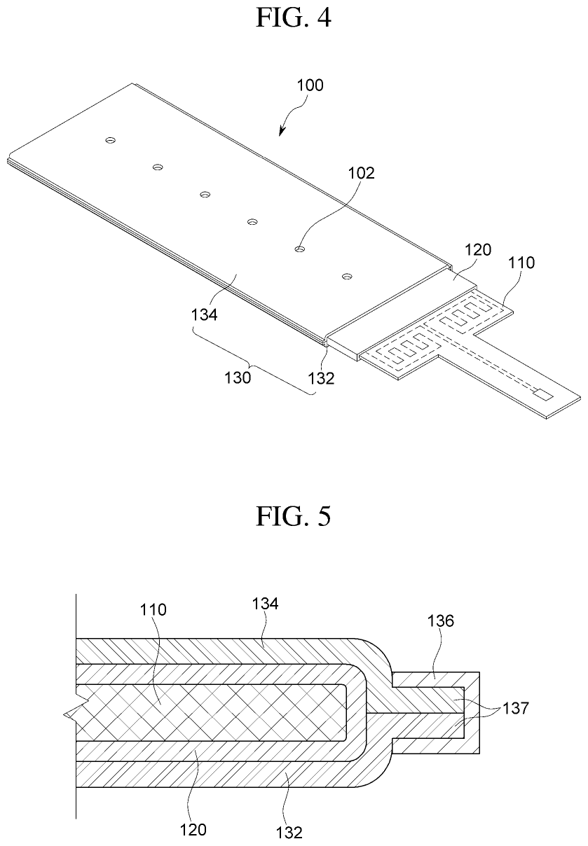

As illustrated in FIG. 4, the plate-shaped heater 100 and the electrical insulator 120 are inserted between the lower and upper sheets 132 and 134, and the through hole 102 and the through space (not illustrated) are connected to each other with a connector. Here, the connector should consider the number of through holes 102 and through spaces and may be designed in various ways depending on the size and mechanical characteristics of the heater.

As illustrated in FIG. 5, the heating module 100 may be configured such that opposite edges 137 of the lower and upper sheets 132 and 134 are connected with a clad sheet 136. Here, the sheet 130 may be formed such that a total thickness of opposite edges is relatively thinner than a thickness of a center portion. This is achieved through a structure that prevents the heater 110 and the electrical insulator 120 from being arranged along opposite edges 137 of the sheet 130, and the reason for forming the edges on opposite sides of the heating module 100 to be thin is to sealingly connect the edges of the sheet 130, that is, the edges 137 of the lower and upper sheets 132 and 134, with the clad sheet 136 by brazing or soldering.

The clad sheet 136 may preferably be formed to be thinner than the lower and upper sheets 132 and 134, that is, less than ¾ of the thickness of the sheet 130, considering the change in shape.

Meanwhile, by applying a pressure on the clad sheet 136 after disposing the lower sheet 132 and upper sheet 134 on lower and upper portions of the heating module 100 including the insulator, respectively, an intermediate shape of the flat heater may be formed. In such a case, if the heating module 100 is positioned inward from an alignment line of ends of the lower sheet 132 and the upper sheet 134 and then a pressure is applied, the lower sheet 132 and the upper sheet 134 may have a structure that surrounds the module itself.

In such a state, if only a side surface of the flexible heater FH is airtightly sealed with the clad sheet 136, and the like, a flat heater protected from the external environment may be completed. Since the heating module 100 is made up of a combination of flexible components, the flexible heater FH completed in this way may naturally have the flexibility to be bent, curved, and the like.

The ‘hermetic seal’, also called a welded seal, completely blocks electrical and electronic components such as semiconductor elements from external air and seals them in a container, preventing the intrusion of moisture and foreign substances and mechanically protecting the device. In such a case, metal, ceramic, glass, and the like are suitable as encapsulating materials, and when metal is used, the same metal material as the lower sheet and upper sheet may be used.

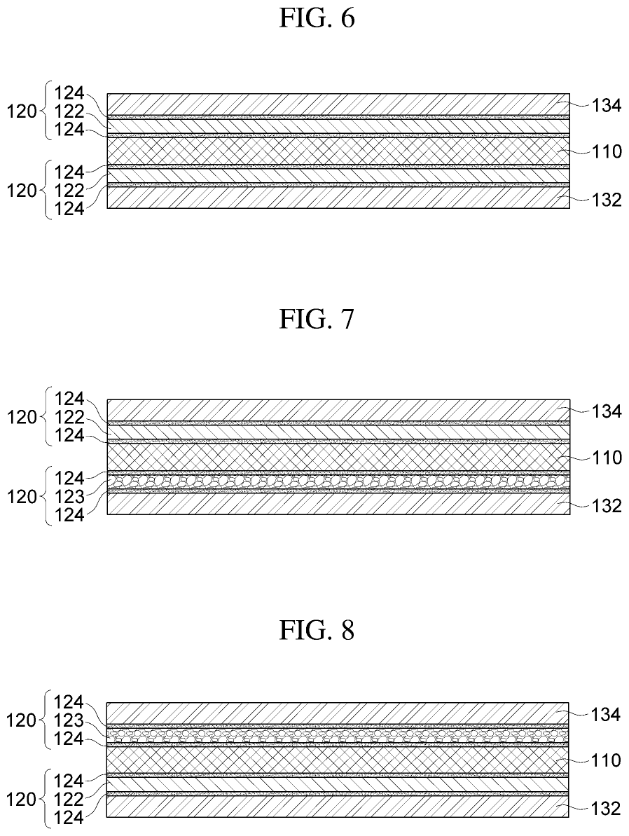

As illustrated in FIGS. 1 and 6, the plate-shaped heater 110 may include, as a heating source located at the center of the heating module 100, a flat metal heater surrounded by a material such as polyimide or polyethylene terephthalate (PET).

The plate-shaped heater 110 may be formed as a film-type heater including at least one conductor of silver (Ag), copper (Cu), CNT (Carbon Nanotube), and graphene as a main component coated with a polymer. In the case of a film-type heater, an electrically conductive material may be screen-printed on the film to form a thin film-type two-dimensional structure. It is obvious that it may be configured as a fabric-type heater.

The plate-shaped heater 110 may be configured such that heating elements made of an alloy sheet such as nichrome or SUS, aluminum (Al), copper (Cu) or the like are formed at regular intervals as an electrical resistance circuit to sense a temperature during heating. Here, the heating element may serve both heating and sensing functions at the same time.

It is obvious that the heating elements in the plate-shaped heater 110 may have various types of patterns as needed.

As illustrated in FIG. 6, the electrical insulator 120 may be disposed each between the plate-shaped heater 110 and the lower sheet 132 and between the plate-shaped heater 110 and the upper sheet 134 and may include an insulating layer 122 having thermal conductivity and an adhesive layer 124 laminated on a lower or upper surface of the insulating layer 122 to form a multi-layer structure.

The electrical insulator 120 preferably has a three-layer structure in which an adhesive layer 124 is formed on each of the lower and upper surfaces of the insulating layer 122, and the adhesive layer 124, the insulating layer 122, and the adhesive layer 124 are sequentially formed.

The insulating layer 122 may be formed into one or more ceramic layers including at least one of mica, silica wool, zirconia, and thin-film alumina.

The adhesive layer 124 is preferably formed by applying a ceramic adhesive to form a layer.

As illustrated in FIGS. 7 and 8, the electrical insulator 120 may be configured such that a heat insulating layer 123 is stacked between the plate-shaped heater 110 and the lower sheet 132 or between the plate-shaped heater 110 and the upper sheet 134 to further improve heating characteristics in one direction.

That is, the electrical insulator 120 blocks heat transfer in a direction in which the heat insulating layer 123 is formed and allows heat transfer only in an opposite direction where the heat insulating layer 123 is not formed, such that the heating module may be heated in one direction.

The heat insulating layer 123 may be formed of a thin insulation film in which hollow silica or glass is dispersed or fine bubbles are widely distributed.

The lower sheet 132 and the upper sheet 134 may be formed of a metal layer made of any one of aluminum, copper, SUS, nichrome, and nickel-based alloy.

Here, the lower sheet 132 and the upper sheet 134 preferably have a thickness in a range of about 5 to 500 μm. In this thickness range, the plate-shaped heater 110 and the electrical insulator 120 may be firmly protected and plastic processing such as bending may be performed smoothly.

In addition, the lower sheet 132 and the upper sheet 134 may be configured to have an additional coating layer formed on a surface of the metal layer using a parylene-based polymer material or a metal thin film.

Here, the coating layer including a parinrene-based polymer material or a metal thin film may improve insulation, adhesion, corrosion prevention, durability, and airtightness on the surfaces of the lower sheet 132 and the upper sheet 134.

As illustrated in FIG. 5, in the sheet 130, the edges of the lower and upper sheets 132 and 134 may be sealingly connected to each other by brazing or soldering using the clad sheet 136, and furthermore, the sheet may be implemented as an integral tube structure although its manufacturability and variability may be relatively low.

Additionally, the edges of the lower and upper sheets 132, 134 may be sealingly connected to each other using the clad sheet 136, and in such a way, it may form a structure in which side surfaces of the plate-shaped heater 110 and the electrical insulator 120 other than the lower and upper sheets 132, 134 are completely surrounded by the metal-containing sheet material, and the sealability and durability of the flexible heater FH may be increased.

As illustrated in FIG. 6, the heating module 100 may have an overall symmetrical structure in which with respect to the plate-shaped heater 110 located in the center, the electrical insulator 120 including the insulating layer 122 and the adhesive layer 124 and the lower sheet 132 are disposed downward and the electrical insulator 120 including the insulating layer 122 and the adhesive layer 124 and the upper sheet 134 are disposed upward.

In addition, as illustrated in FIG. 7, the heating module 100 may be configured such that with respect to the plate-shaped heater 110 located in the center, the electrical insulator 120 including the heat insulating layer 123 and the adhesive layer 124 and the lower sheet 132 are disposed downward and the electrical insulator 120 including the insulating layer 122 and the adhesive layer 124 and the upper sheet 134 are disposed upward.

On the contrary, as illustrated in FIG. 8, the heating module 100 may be configured such that with respect to the plate-shaped heater 110 located in the center, the electrical insulator 120 including the heat insulating layer 123 and the adhesive layer 124 and the upper sheet 134 are disposed upward and the electrical insulator 120 including the insulating layer 122 and the adhesive layer 124 and the lower sheet 132 are disposed downward.

According to the flexible heater FH according to the first embodiment of the present disclosure, the plurality of through spaces 102 are firstly formed in the heating module 100 along the space in which the heating pattern is not partially formed in the plate-shaped heater 110, and by caulking the through space 102 using the connection means 104 such as a rivet, the sheet 130 may maintain its shape without being delaminated when changing the shape of the heating module 100.

Accordingly, it is possible to provide a flexible heater that is sturdy and easy for plastic processing such as bending and curving.

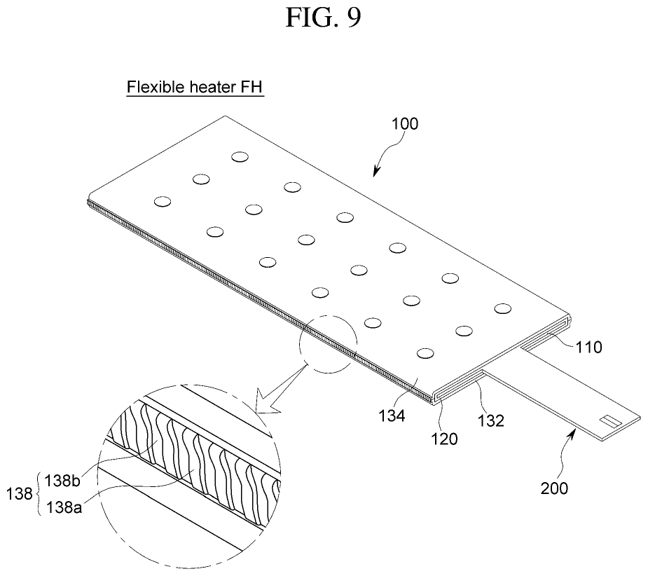

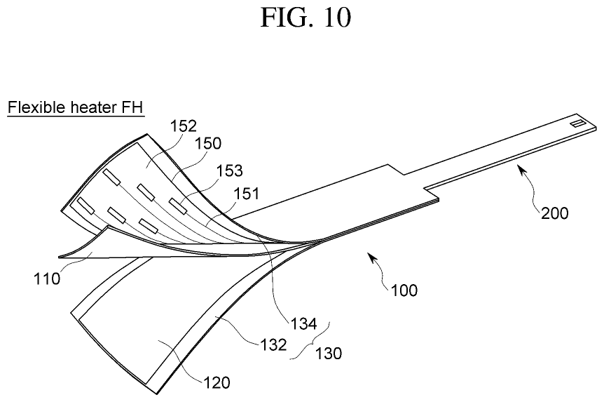

FIG. 9 is a configuration diagram illustrating a flexible heater according to a second embodiment of the present disclosure.

A flexible heater FH according to the second embodiment of the present disclosure, as in the first embodiment, includes, as a heating module 100, a plate-shaped heater 110 having flexibility, an electrical insulator 120 having flexibility, and a sheet 130 including lower and upper sheets 132 and 134 having flexibility. Here, since the plate-shaped heater 110 and the electrical insulator 120 are identical to the configuration of the first embodiment, their detailed description will be omitted.

A feature of the second embodiment of the present disclosure is that after edges of the lower and upper sheets 132 and 134 are brought together in the heating module 100, a weld surface 138 is formed using a joining means below a melting point of the sheet material.

According to the second embodiment of the present disclosure, there is an advantage that it is possible to manufacture a flexible flat heater that is much easier to change shape, such as bending, through a relatively simple process of forming a weld surface.

In such a case, as the weld surface 138, it is preferable to form peaks 138a and valleys 138b at regular intervals along a side surface through surface processing using a laser, and the like, and the peaks 138a and the valleys 138b formed in the weld surface 138 may facilitate bending and curving processing of the heating module 100.

In such a case, a wave pattern may be formed on the weld surface due to the peaks 138a and valleys 138b, and a depth at which this wave pattern is formed is preferably less than 30% of a thickness of the flat heater.

In such a case, the joining means may use a brazing material or a nano ink material that may be sintered at low temperature. It is obvious that various materials may be used for the brazing material, including hard solder, which have a bonding strength of a certain level or higher and do not cause deformation in the sheet material itself.

According to the flexible heater according to the second embodiment of the present disclosure, when it is not easy to immediately form peaks and valleys when performing fusion welding, after bringing together the edges of the lower and upper sheets 132 and 134 and forming the weld surface 138 using a brazing material or a nano ink material, the weld surface 138 may be etched to form the peaks 138a and the valleys 138b. Even if the peaks 138a and valleys 138b are formed through this etching process, the effect of improving the variable characteristics such as bending of the heating module 100 may be the same.

FIG. 10 is a configuration diagram illustrating a flexible heater according to a third embodiment of the present disclosure.

A flexible heater FH according to the third embodiment of the present disclosure, as in the first and second embodiments, includes, as a heating module 100, a plate-shaped heater 110 having flexibility, an electrical insulator 120 having flexibility, and a sheet 130 having flexibility, and further includes a temperature sensor 150 mounted along an inner surface of the sheet 130 to detect a temperature for each part. Here, the heating module 100 has a technical characteristic in that its shape is curved and deformed three-dimensionally to expand a surface area of the plate-shaped heater 110 that is in contact with a heating medium in a certain heating space.

The temperature sensor 150 has a structure in which a sensing element 153 is located on a flexible sheet-shaped insulating layer 152 on which a wiring electrode 151 is formed.

In addition, since the temperature sensor 150 is designed to have an overall thin sheet-shaped structure, an area in contact with a region to be measured may be increased such that thermal equilibrium may be reached in a short time, allowing accurate temperature measurement.

The wiring electrode 151 is generally made of a material with high electrical conductivity, such as copper, aluminum, silver, or gold, and is placed on or inside the sheet-shaped insulating layer 152 through methods such as thick film printing, lamination, and etching.

The sheet-shaped insulating layer 152 is an insulating protective layer for the temperature element and is made of one of various resins such as vinyl, epoxy, phenol, Teflon, and silicone, or a composite material thereof.

Meanwhile, the sensing element 153 serves to convert heat detected from an object being measured (water or fluid contained therein in the case of a medium-to-large tank) into an electric signal, and a shape of the element is such that a wide surface of the element is parallel to the flat heater.

In addition, the sensing element 153 is made of any one of a negative temperature coefficient (NTC) thermistor element material, copper, nickel, nickel-based alloy, platinum, and platinum-based alloy, and has a flexible thick film structure.

Here, the temperature sensor 150 is provided with the sensing elements 153 at multiple points and may sense the temperature at each portion of the heater 110 of the heating module 100. Through this temperature sensor 150, a state of the heater 110 of the heating module 100 may be accurately monitored from the outside.

The flexible heater FH according to the third embodiment of the present disclosure may be coated with various coating materials such as silicone and perylene to ensure airtightness in the connection portion and the surface of the sheet 130. It is obvious that as in the first and second embodiments, the through hole 102 of the sheet 130 and part of the through space of the heater 100 and the electrical insulator 120 are connected by a connector such that the sheet 130 is not delaminated.

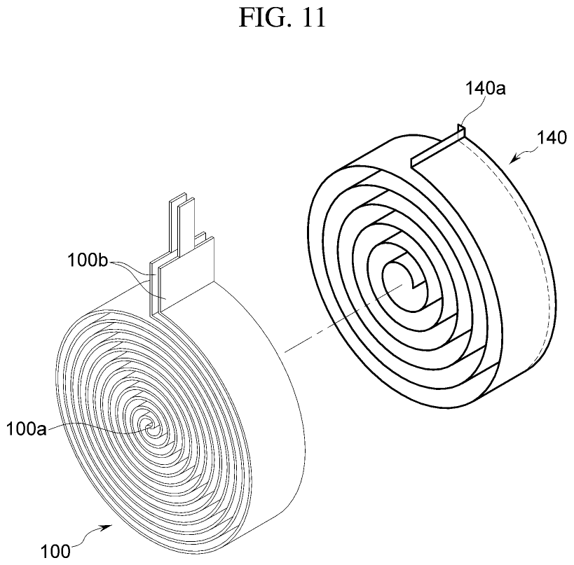

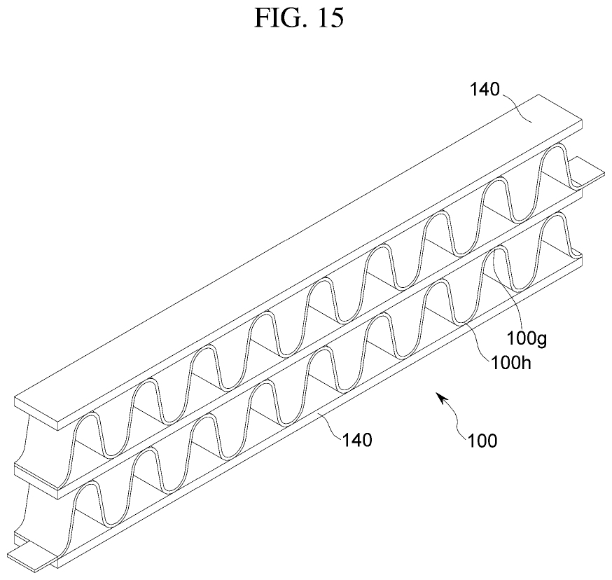

Moreover, the flexible heater FH according to the third embodiment of the present disclosure may further include a shape maintainer 140 configured to maintain a shape of the bent and deformed heating module 100 or maintain a gap of the heaters 110 at regular intervals when stacking the heating module 100 into one or more layers (see FIGS. 11 and 15). Here, it is obvious that the shape maintainer 140 may be configured as a support that supports the heating module 100. It is preferable that the shape maintainer 140 or support be configured to maintain the shape of the heater 100 at equal intervals as much as possible.

As illustrated in FIGS. 11 to 15, the heating module 100 may be implemented in various shapes such as concentric, symmetrical, radial, and wavy shapes. The heating module 100 is exemplified as concentric, symmetrical, radial, and wave-shaped, and it is obvious that the heating module 100 may be implemented in various other forms. The shape maintainer 140 may have a different support structure depending on the bent shape of the heating module 100.

First, as illustrated in FIG. 11, the concentric heating module 100 may be wound to have a certain radius in a concentric direction from a central bent portion 100a and may be configured such that opposite ends 100b are arranged in the same direction.

The concentric heating module 100 may be wound to have a certain radius at regular intervals in a clockwise or counterclockwise direction while forming the central bent portion 100a, and the shape maintainer 140 may be disposed between the concentric heating module 100 to maintain the shape. Accordingly, the concentric heating module 100 may maintain its shape and increase heating efficiency by expanding a heating surface area even in a limited space.

Meanwhile, although not illustrated in the drawings, the concentric heating module 100 may be configured into a multi-layer structure by overlapping flange portions 140a of the plurality of shape maintainers 140 in contact with each other.

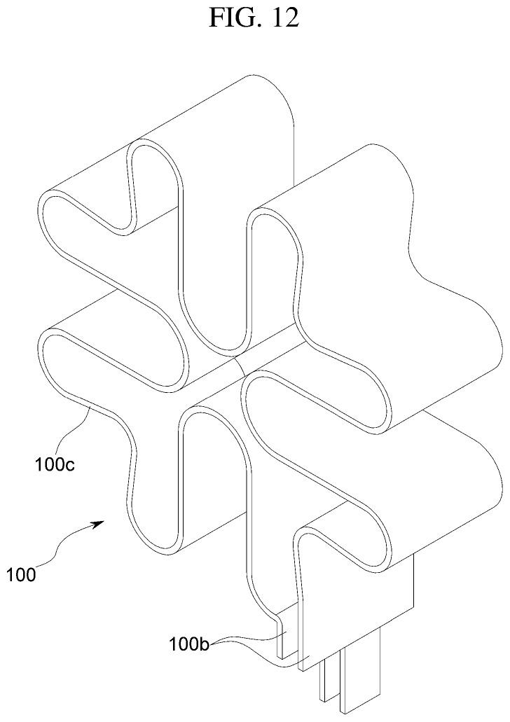

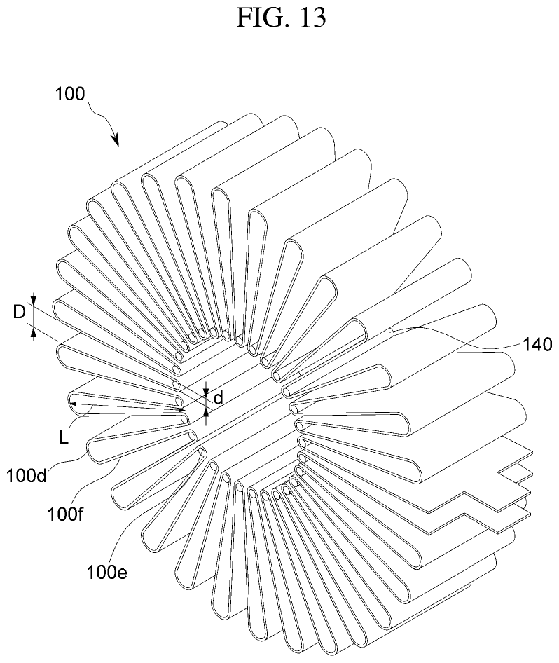

Next, as illustrated in FIG. 12, a symmetrical heating module 100 may be configured such that a plurality of bent portions 100c are formed symmetrically in facing directions, and opposite ends 100b are arranged in the same direction.

The symmetrical heating module 100 may be formed with a plurality of bent portions 100c opposing each other along a virtual circumferential surface, such that it may heat a heating medium in a certain space. Here, in order to expand a heating surface area, a structure of the symmetrical heating module 100 may be changed into various shapes to form more bent portions 100c. In addition, although not illustrated in the drawings, the symmetrical heating module 100 may be configured as a multi-layer structure by overlapping it using a shape maintainer (not illustrated) to expand the heating surface area.

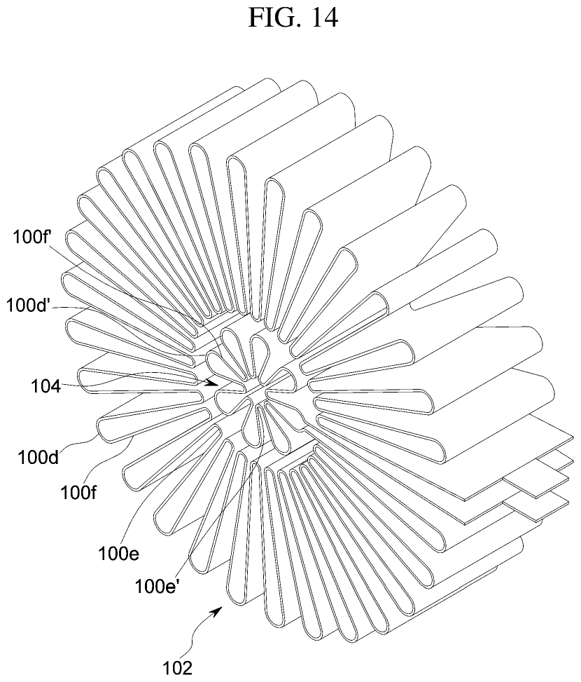

Next, as illustrated in FIG. 13, a radial heating module 100 includes a flat portion 100f formed having a certain length L along a circumferential surface between an outer bent portion 100d and an inner bent portion 100e, and a distance D between the outer bent portions 100d is relatively wider than a distance D between the inner bent portions 100e. Here, it is preferable that in the radial heating modules 100, the distance gradually widens from the inner bent portion 100e to the outer bent portion 100d. In the radial heating module 100, although a tip end forming a terminal is not illustrated, but it may be formed outwardly, and if necessary, may be formed inwardly using the shape maintainer 140.

Another form of the radial heating module 100 is divided into an outer first radial portion 102 and an inner second radial portion 104, as illustrated in FIG. 14. Here, the first radial portion 102 includes an outer bent portion 100d, an inner bent portion 100e, and a flat portion 100f, and the second radial portion 104 includes an outer bent portion 100d′, an inner bent portion 100e′, and a flat portion 100f′.

This radial heating module 100 may vary a heating surface area according to a length of the flat portion 100f and a level of bending of the outer bent portion 100d and the inner bent portion 100e and may maintain its shape using the shape maintainer 140 to thereby heat a heating medium appropriately in space.

Lastly, as illustrated in FIG. 15, a waveform heating module 100 may be configured such that convex portions 100g and concave portions 100h are arranged alternately having a certain area to form a waveform in a cross-section. Here, in the waveform heating module 100, the convex portions 100g and the concave portions 100h may be formed in a longitudinal direction and may be formed at a predetermined angle with respect to the longitudinal direction.

The waveform heating module 100 may be stacked into a multi-layer structure using the shape maintainer 140 to increase heating efficiency by expanding the heating surface area even in a limited space.

According to the flexible heater according to the third embodiment of the present disclosure, heat transfer efficiency may be increased by expanding the heating surface area as the shape of the heating module 100 is bent and deformed, and depending on a space of a heating medium, a type of the heating medium, a flow state of the heating medium, the concentric, symmetrical, radial, or waveform-type heating modules 100 may be selected and applied. In addition, the heating module 100 may be stacked into a multi-layer structure while maintaining its shape using the shape maintainer 140, thereby expanding the heating surface area to increase the heating efficiency even in a limited space. Moreover, since a temperature sensor 150 is mounted along an inner surface of the sheet 130, the temperature may be detected at each part of the heater 110 of the heating module 100, such that a status of the heater 110 of the heating module 100 may be accurately monitored from the outside.

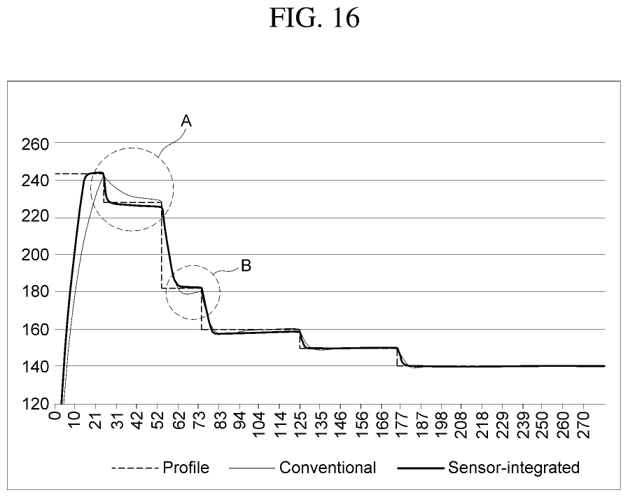

FIG. 16 is a graph showing a temperature profile in a heating tank according to the present disclosure, where a horizontal axis represents time (minutes) and a vertical axis represents temperature.

A ‘dotted line’ represents a profile of temperature control, a ‘solid line’ represents a conventional temperature change during heating/cooling by a flat heater without a temperature sensor attached, and a ‘bold solid line’ represents a temperature change of a sensor-integrated flat heater in which the temperature sensor 150 is integrated as in the third embodiment of the present disclosure.

As may be seen from FIG. 16, when the sensor-integrated flat heater using the heating module 100 with the integrated temperature sensor 150 is used, it was confirmed that the designed temperature profile is precisely followed without a large error at a high temperature section (A, around 200° C.) and a medium temperature section (B, around 180° C.).

Accordingly, it may be assumed that the heating module 100 with the built-in temperature sensor 150 may measure temperature conditions close to actual conditions not only at low and medium temperatures but also at high temperatures.

Although exemplary embodiments of the present disclosure have been illustrated and described as described above, various modifications and other embodiments may be practiced by those skilled in the art. These modifications and other embodiments are to be considered and included in the appended claims without departing from the true spirit and scope of the present disclosure.

A heating module according to the present disclosure may secure flexibility to bend into any shape and may increase a specific surface area per unit volume when immersed in liquid. In addition, by embedding a temperature sensor with a plurality of sensing elements in the heating module, it is possible to precisely measure each part of a heater and monitor a temperature status of the heater from the outside.

1. A flexible heater comprising a heating module comprising, wherein the heating module comprises:
a plate-shaped heater having flexibility;
an electrical insulator surrounding the plate-shaped heater and having flexibility; and
a sheet surrounding the plate-shaped heater and the electrical insulator and having flexibility,
wherein in the heating module, a plurality of through spaces penetrating the sheet are arranged at regular intervals with respect to a position where a heating pattern of the plate-shaped heater is not formed, and
a lower sheet and an upper sheet are connected to each other by a connector in part of the plurality of through spaces.

2. The flexible heater of claim 1, wherein the connector integrally connects the through space using a connection means or a fusion material, and
wherein a connection portion of the connector and the lower and upper sheets is airtight.

3. The flexible heater of claim 1, wherein the heating module has a thickness of opposite edges that is relatively thinner than a thickness of a center portion, and
wherein edges of the lower sheet and the upper sheet are sealingly connected to each other.

4. The flexible heater of claim 1, wherein the heating module has a thickness of opposite edges that is relatively thinner than a thickness of a center portion, and
wherein edges of the lower sheet and the upper sheet are joined using a joining means to form a weld surface.

5. The flexible heater of claim 4, wherein the weld surface has peaks and valleys formed at regular intervals.

6. The flexible heater of claim 1, wherein the plate-shaped heater is formed as a fabric-type heater or a film-type heater including at least one conductor of silver, copper, CNT, and graphene as a main component coated with a polymer.

7. The flexible heater of claim 1, wherein the plate-shaped heater is configured such that heating elements made of an alloy are formed at regular intervals as an electrical resistance circuit to sense a temperature during heating.

8. The flexible heater of claim 1, wherein the electrical insulator is formed in a multi-layer structure including two or more layers by alternately stacking thermally conductive insulating layers and adhesive layers.

9. The flexible heater of claim 8, wherein in the electrical insulator, the insulating layer includes one or more ceramic layers including at least one of mica, silica wool, zirconia, and thin-film alumina, and
wherein the adhesive layer is formed of a ceramic-based adhesive.

10. The flexible heater of claim 8, wherein the electrical insulator is configured such that the heating module is heated in opposite directions or in one direction by forming a heat insulating layer on one side of the insulating layer.

11. The flexible heater of claim 10, wherein the heat insulating layer is formed as a thin heat insulating film in which hollow silica or glass is dispersed, or fine bubbles are widely distributed.

12. The flexible heater of claim 1, wherein the sheet is formed of a metal layer including any one of aluminum, copper, SUS, nichrome, and nickel-based alloy.

13. The flexible heater of claim 12, wherein in the sheet, a coating layer using a parinrene-based polymer material or a metal thin film is additionally formed on a surface of the metal layer.

14. The flexible heater of claim 1, wherein the heating module further comprises a temperature sensor mounted along an inner surface of the sheet, the temperature sensor configured to detect a temperature of each part.

15. The flexible heater of claim 14, wherein the temperature sensor has a structure in which a thin sensing element is stacked on a flexible sheet-shaped insulating layer on which an internal wiring electrode is formed.

16. The flexible heater of claim 15, wherein the sensing element of the temperature sensor is made of any one of a negative temperature coefficient thermistor element material, copper, nickel, nickel-based alloy, platinum, and platinum-based alloy.

17. A method of manufacturing a flexible heater, the method comprising:
forming a plate-shaped heater by stacking a plurality of heater patterns on an insulating polymer film;
forming an electrical insulator by alternately laminating thermally conductive insulating layers and adhesive layers on a surface of the plate-shaped heater;
forming a sheet by disposing a lower sheet and an upper sheet on the electrical insulator;
forming a heating module by pressing a structure in which the plate-shaped heater, the electrical insulator, and the sheet are stacked; and
forming a through portion in the lower sheet and the upper sheet and caulking the through portion with a connector.

18. The method of claim 17, further comprising, after disposing the lower sheet and the upper sheet and forming the heating module by pressing:
sealingly connecting edges formed by the sheet.

19. The method of claim 18, wherein the sealingly connecting the edges formed by the sheet in comprises sealingly connecting the edges using a clad sheet.

20. The method of claim 17, further comprising, after forming the plate-shaped heater and forming the electrical insulator on the surface of the plate-shaped heater:
forming a temperature sensor.
